(19) United States
(12) Patent Application Publication
(10) Pub. No.: US 2009/0039126 A1
(43) Pub. Date: Feb. 12, 2009

(54) RETRACTABLE CUP HOLDER

(75) Inventors: Kyosuke YAMAGISHI, Utsunomiya-shi (JP); Yuichi Mori, Hino-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: HINO MOTORS, LTD.T, Tokyo (JP)

(21) Appl. No.: 12/184,519

(22) Filed: Aug. 1, 2008

(30) Foreign Application Priority Data
Aug. 6, 2007 (JP) 2007-203796

(51) Int. Cl. B60R 7/06; B60N 3/10

(52) U.S. Cl. 224/281; 296/37.8

(57) ABSTRACT

A retractable cup holder has a tray for receiving a bottom of a cup, a support for holding a barrel of the cup, the support being superimposed on the tray when retracted and being raised up, in use, from the tray to a height necessary for holding the cup. A retainer locks, in use, the support in the raised-up position and is allowed to unlock the support through retraction motion of the cup holder. Thus, in use, the cup is sufficiently held in position and backlash of the support due to vibrations during travel is prevented.

### BACKGROUND OF THE INVENTION

1. Field of the Invention

The present invention relates to a retractable cup holder.

2. Description of the Related Art

In general, a cup holder used in a cabin of an vehicle is retracted in a proper in-vehicle structure when not in use, and is drawn from the structure for use where necessary. Some cup holders have supports each, in use, raised up from a tray receiving a bottom of a cup to hold a barrel of the cup.

Specifically, the support of such kind of cup holder is formed with an opening into which the cup is inserted to be circumferentially held at its barrel by the support. The support is superposed on the tray when retracted and is raised up, in use, from the tray by means of biasing force of a spring to a height necessary for holding the cup.

This kind of retractable cup holder is disclosed, for example, in JP 2003-245162A.

However, in the conventional retractable cup holder as shown in the publication, accidental application of pushdown load on the support raised up only by the biasing force of the spring, may cause the support to be readily lowered against the biasing force, disadvantageously resulting in failure of holding the cup in position, leading to easy tumble the cup. Moreover, vibrations of such cup holder during travel may cause abnormal noise due to backlash of the support.

### SUMMARY OF THE INVENTION

The invention was made in view of the above and has its object to provide a retractable cup holder which, in use, can properly keep a cup in position and can prevent backlash of a support through vibrations during travel.

The invention is directed to a retractable cup holder comprising a tray for receiving a bottom of a cup, a support for holding a barrel of said cup, said support being superposed on the tray when retracted and being raised up, in use, from the tray by means of biasing force of a spring to a height necessary for holding the cup, and a retainer for locking, in use, the support in a raised-up position, said retainer being allowed to unlock the support through retracting motion of the cup holder.

Thus, the support superposed on the tray when retracted is raised up, in use, from the tray to the height necessary for holding the cup and is locked in the raised-up position by the retainer, so that even if accidental pushdown load is applied on the support in the raised-up position, there is no fear of the support being readily lowered; there is no fear of backlash of the support caused due to vibrations during travel.

When the support is superposed on the tray for retraction, the retainer is allowed to unlock the support through the retracting motion of the cup holder. Thus, no special operation is needed for causing the retainer to unlock the support. The cup holder has easy-to-use operativity competitive with the conventional retractable cup holders.

Preferably, the cup holder is constructed such that the tray is retracted together with the support to a wall of the in-vehicle structure in a standing-up position and is spread out about a first rotation center at a bottom, in use, into a substantially horizontal position, that the support is raised up, in use, from the tray by means of a biasing force of a resilient body about a second rotation center on the tray and that the retainer is raised up, in use, about a third rotation center on the tray between the support and the tray by means of biasing force of a resilient body and is engaged with a latch on said support to lock the support in a raised-up position.

With the retractable cup holder being thus constructed, the tray retracted together with the support to the wall of the in-vehicle structure in the standing-up position is spread out, in use, about the first rotation center into a substantially horizontal position, so that the support is raised up about the second rotation center by means of biasing force of the resilient body while the retainer is raised up between the raised-up support and the tray by means of biasing force of the resilient body about the third rotation center and is engaged with the latch on the support to lock the support in the raised-up position.

The support is preferably formed, at a portion thereof adapted to be supported by the retainer, with a small opening through which a projection on the wall of the in-vehicle structure may push and unlatch the retainer upon retraction.

With the retractable cup holder thus constructed, the tray spread out in the substantially horizontal position is raised up about the first rotation center for retraction to the wall of the structure, the projection on the wall may push and unlatch the retainer via the small opening to unlock the support through retracting motion of the cup holder.

By a finger, the retainer may be pushed down via the small opening to unlatch the retainer while the tray remains to be spread out substantially horizontally.

An embodiment of the invention will be described in conjunction with attached drawings.

### BRIEF DESCRIPTION OF THE DRAWINGS

FIG. 1 is a perspective view showing an embodiment of a retractable cup holder according to the invention in use;

FIG. 2 is a perspective view showing the cup holder of FIG. 1 in a retracted position;

FIG. 3 is a perspective view showing only the cup holder in FIG. 1;

FIG. 4 is a sectional view showing the cup holder of FIG. 1 in the retracted position;

FIG. 5 is a sectional view showing the cup holder of FIG. 1 in use;

FIG. 6 is a sectional view showing the cup holder just after unlocking of the support by the projection shown in FIG. 4; and

FIG. 7 is a sectional view showing the cup holder in use after unlocking of the support, using a finger.

### DESCRIPTION OF THE PREFERRED EMBODIMENTS

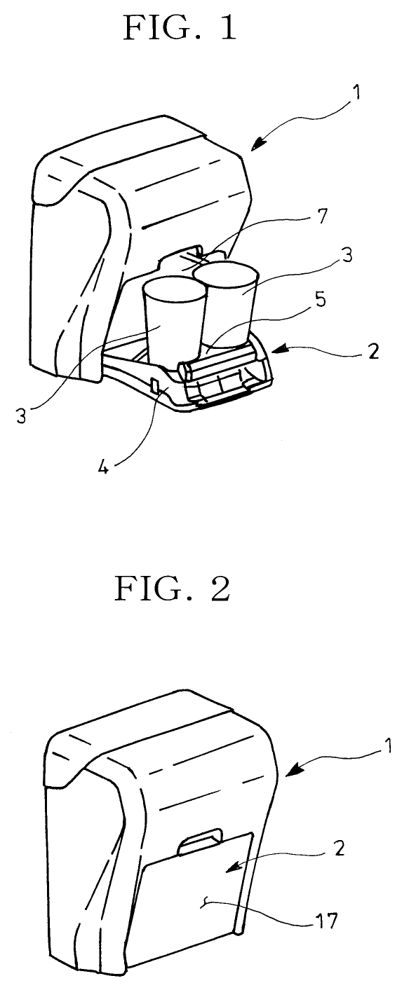

FIGS. 1-7 show an embodiment of the invention. With FIGS. 1 and 2 showing the embodiment in use and in retracted position, respectively, the illustrated embodiment exemplifies a retractable cup holder 2 arranged on a back surface (or wall) of an armrest 1 (in-vehicle structure) between driver's and assistant driver's seats. The cup holder 2 comprises a tray 4 which receives a bottom of a cup 3 and a support 5 which holds a barrel of the cup 3, the support 5 being superposed on the tray when retracted and being raised up, in use, from the tray 4 to a height necessary for holding the support 5.

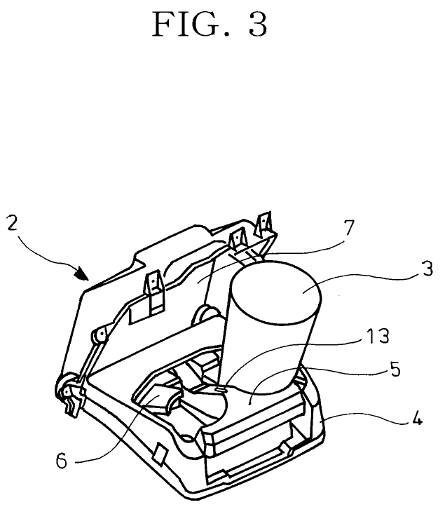

More specifically, as perspectively shown in FIG. 3 with respect to the retractable cup holder 2 only, the support 5 is in the form of T when seen from the above. The support 5 comprises a central portion extending longitudinally of the vehicle and lateral extensions oppositely extending from a tip of the central portion to provide corners each of which is arc-shaped complementarily with an outer periphery of the barrel of the cup 3 and can cooperate with an auxiliary holder 6 on the tray 4 to hold the barrel of the cup 3.

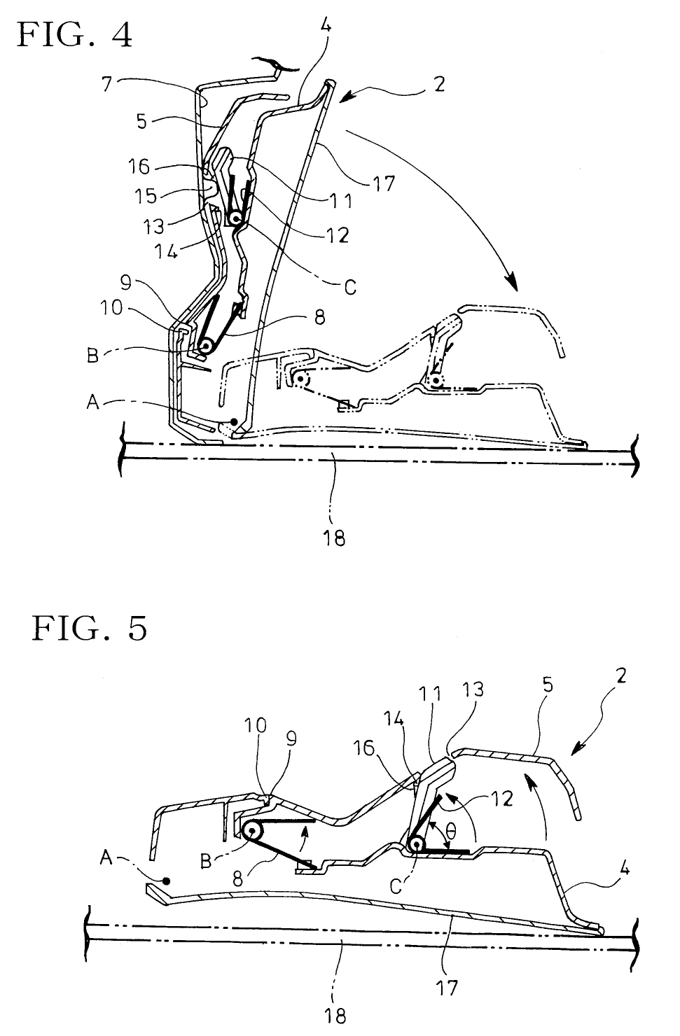

As shown in cross-section in FIG. 4, the back surface of the armrest 1 is concaved to provide a docking chamber 7 which receives the retractable cup holder 2 in a flattened manner. The tray 4 is retracted together with the support 5 into the docking chamber 7 in a standing-up position and is spread out, in use, about a first rotation center A at a bottom substantially horizontally (see two-dot chain lines in FIG. 4).

The support 5 has one end which provides a lower end in a retracted position and which is connected to the tray 4 for tilted motion at a second rotation center B thereon. As shown in FIG. 5, the support 5 is raised up, in use, from the tray 4 by means of a biasing force of a torsion coiled spring 8 (resilient body) fitted over the second rotation center B, and stays in a predetermined raised-up position through abutting of a stepwise stopper 9 on the support 5 adjacent to the second rotation center B against an abutment 10 of the tray 4.

In the embodiment of the retractable cup holder 2 thus constructed, a retainer 11 is provided to lock, in use, the support 5 in the raised-up position and is allowed to unlock the support 5 through retraction motion of the cup holder 2. The retainer 11 is constructed such that it is raised, in use, about a third rotation center C on the tray 4 between the support 5 and the tray 4 by means of biasing force of a torsion coiled spring 12 (resilient body) and is engaged with a latch 14 on the support 5 adjacent to just above the third rotation center C to lock the support 5 in the raised-up position.

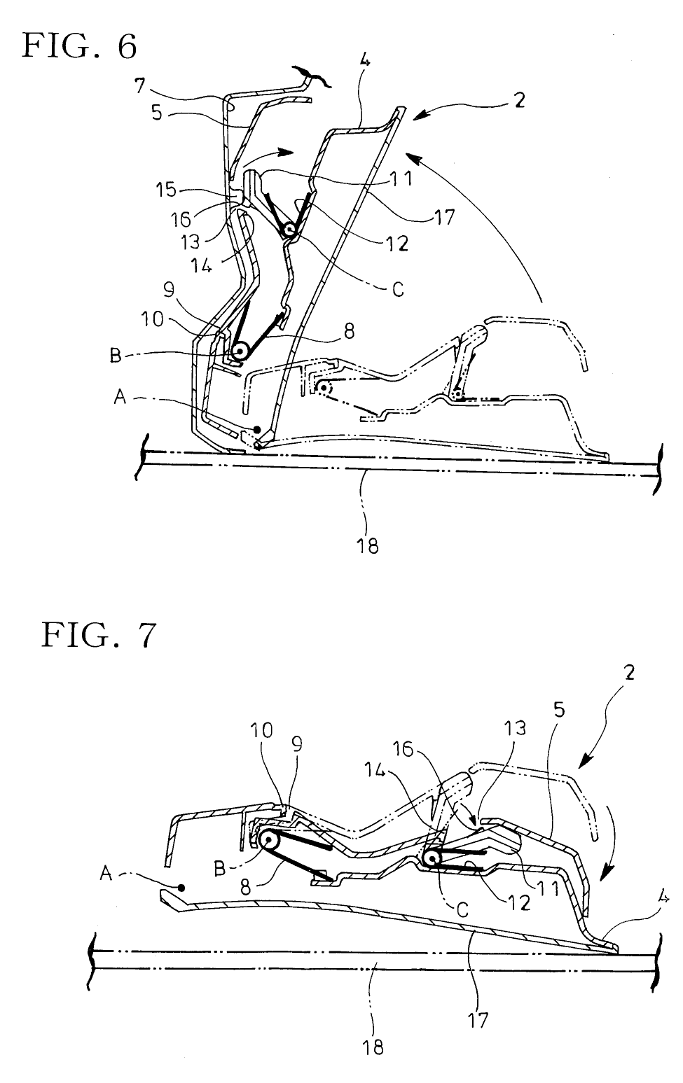

More specifically, the support 5 is formed with a small opening 13 at a portion thereof adapted to be supported by the retainer 11, one edge of the small opening 13 is formed with the latch 14 which protrudes downward in use. With a tip of the retainer 11 being fitted into the opening 13, a stopper 16 on the retainer 11 is engaged with the latch 14. Moreover, as best shown in FIG. 6, the docking chamber 7 of the armrest 1 is provided with a projection 15 which, when the cup holder 2 is retracted, pushes the tip of the retainer 11 via the small opening 13 to unlock the engagement of the stopper 16 against the latch 14.

In this case, as best shown in FIG. 5, a position of engagement of the stopper 16 on the retainer 11 with the latch 14 on the support 5 is set to be slightly offset with respect to vertical passing through the third rotation center C in a direction of tilt of the retainer 11 and the retainer 11 is adapted to be locked with a depression angle θ less than 90° relative to an adjacent upper surface of the tray 4; excessive pushdown load more than a predetermined one applied on the support 5 releases the engagement of the stopper 16 with the latch 14.

The retainer 11 is set such that, when fitted into the small opening 13, the tip end of the retainer 11 is slightly withdrawn downward with respect to an upper surface of the support 5, which prevents for example the bottom of the cup 3, when placed on the tray, from accidentally hitting the tip of the retainer 11 to improperly cause unlocking.

In the figures, reference numeral 17 denotes a lid integrally formed on the tray 4 which provides a back of the armrest 1 when the cup holder 2 is retracted to snugly close the docking chamber 7; and 18, a carpet laid on a floor in the interior of the vehicle.

With the retractable cup holder 2 thus constructed, the tray 4 retracted together with the support 5 in the docking chamber 7 on the back of the armrest 1 in the standing-up position is spread out substantially horizontally about the first rotation center A so that the support 5 is raised up about the second rotation center B by means of the biasing force of the torsion coiled spring 8 to a height necessary for holding the cup 3, the retainer 11 being raised up between the raised-up support 5 and the tray 4 about the third rotation center C by means of the biasing force of the torsion coiled spring 12. Thus, the retainer 11 is engaged with the latch 14 on the support 5 near just above the third rotation center C, so that the support 5 in the raised-up position is supported by the retainer 11 into locking.

As a result, even if pushdown load is applied erroneously on the support 5 in the raised-up position, there is no fear of the support 5 being readily lowered. There is no fear of backlash of the support 5 caused due to vibrations during travel.

However, when excessive pushdown load more than the predetermined one is applied on the support 5 in a case where a crew accidentally foots the support 5 in the raised-up position or where he or she falls down to locate his or her hand on the support 5, the engagement of the retainer 11 with the latch 14 is loosened before breakage of support 5 and the like to unlock the support 5.

When the tray 4 spread out substantially horizontally is raise up about the first rotation center A to be retracted into the docking chamber 7 on the back of the armrest 1, the projection 15 in the docking chamber 7 is allowed to push out, via the small opening 13 of the support 5, the tip of the retainer 11 to loose the engagement of the retainer 11 with the latch 14 to unlock the support 5 through the retraction motion of the cup holder 2. Thus, no special operation is needed for causing the retainer 11 to unlock the support. The cup holder has easy-to-use operativity competitive with the conventional retractable cup holders.

By a finger, the retainer may be pushed down as shown in FIG. 7 via the small opening 13 to unlatch the retainer 11 or loosen the engagement of the stopper 16 of the retainer 11 with the latch 14 while the tray remains to be speared out substantially horizontally.

Thus, according to the above embodiment, the support 5 in use in the raised-up position can be supported and locked by the retainer 11, so that the cup 3 can be sufficiently maintained in position to prevent the tumble of the cup 3 due to accidental operation from occurring and backlash of the support 5 due to vibrations during travel can be prevented to prevent the abnormal noise from being produced. Moreover, the retainer 11 is allowed to be loosened through retraction motion of the cup holder 2, so that no special operation is needed for causing the retainer 11 to unlock the support 5. The cup holder has easy-to-use operativity competitive with the conventional retractable cup holders.

It is to be understood that a retractable cup holder according to the invention is not limited to the above-mentioned embodiment and that various changes and modifications may be made without leaving the scope of the invention. For example, the retractable cup holder may be of slide type. The in-vehicle structure to which the retractable cup holder is retracted is not limited to the armrest.

What is claimed is:

1. A retractable cup holder comprising a tray for receiving a bottom of a cup, a support for holding a barrel of said cup, said support being superposed on the tray when retracted and being raised up, in use, from the tray to a height necessary for holding the cup, and a retainer for locking, in use, the support in a raised-up position, said retainer being allowed to unlock the support through retracting motion of the cup holder.

2. A retractable cup holder as claimed in claim 1, wherein the cup holder is constructed such that the tray is retracted together with the support to a wall of an in-vehicle structure in a standing-up position and is spread out about a first rotation center at a bottom, in use, into a substantially horizontal position, that the support is raised up, in use, from the tray by means of a biasing force of a resilient body about a second rotation center on the tray and that the retainer is raised up, in use, about a third rotation center on the tray between the support and the tray by means of biasing force of a resilient body and is engaged with a latch on said support to lock the support in the raised-up position.

3. A retractable cup holder as claimed in claim 2, wherein the support is formed, at a portion thereof adapted to be supported by the retainer, with a small opening through which a projection on the wall of the in-vehicle structure pushes and unlatches the retainer upon retraction.
